(19) United States
(12) Patent Application Publication
(10) Pub. No.: US 2006/0241890 A1
(43) Pub. Date: Oct. 26, 2006

(54) Radiant heater in a cooking hob with a thermal switch

(75) Inventors: Daniel de los Toyos, Eibar (ES); Jon Endika Azpiritzaga, Durango (ES)

Correspondence Address: THE KLINE LAW FIRM, P.C., 161 Little Pond Lane, Palmyra, VA, 22963-5161, US

(73) Assignee: EIKA, S. Coop, ETXEBARRIA (Bizkaia) (ES)

(21) Appl. No.: 11/473,203

(22) Filed: Jun. 22, 2006

Related U.S. Application Data
(63) Continuation-in-part of application No. 10/965,924, filed on Oct. 14, 2004, now Pat. No. 7,087,866.

(30) Foreign Application Priority Data
Jun. 14, 2004 (ES) U-200401433

(51) Int. Cl. G01K 11/30

(52) U.S. Cl. 702/134

(57) ABSTRACT

The electric radiant heater (101) adapted to a cooking hob is attached to the cooking plate (2a) forming with it an air cavity (13) in which the extended heating resistor (105) is housed on an insulating base (104). A peripheral outer wall (3,6) of the heater defines said cavity (13) in which there is a thermal switch (107) positioned, having a bimetal sensor (107c) the compact body (107a) of which rests on a central area (104a) of the insulating base, and its metal heat-receiving base (107b) in a position facing a heating resistor segment (105a) and either very close to or above it making contact. The relative position of the bimetal sensor (107c) enables a switching point (SWC′,SWO′) of the electrical contact (109) to be set in correlation to the hotplate warning light temperature range (TU).

### DESCRIPTION

The present application is a “continuation in part” of the parent application U.S. Ser. No. 10/965,924, filed at Oct. 14/2004, and now published as US 2005/0274710-A1.

### TECHNICAL FIELD

The invention is related to a radiant heater for an electric cooking hob, provided with a thermal switch for turning on and off a warning lamp to indicate a state of the hot plate during heating and cooling.

### PRIOR ART

Radiant heaters of the above-mentioned type are known, with a built-in thermal switch whose electrical contact is used for switching on a warning lamp indicating that the cooking plate is still “hot” with a hazardous residual temperature, the threshold of which is set at 60-70° C. The thermal switch has to switch the warning contact during the onset of the heating of the cooking plate as well as during cooling to warn of a residual temperature higher than the aforesaid threshold value. The bimetallic sensor does not make direct contact with the hot plate, but the switch response time should be correlated to the actual temperature of the heated plate zone. For this purpose the thermal switch is situated on an peripheral insulating zone of the heater receiving proportionally the heat transmitted to the plate, so that the temperature value reached in the sensing element, always higher than on the plate, closely follows the changes in said real value in the plate. The switch actuating point is set at a suitable temperature point for switching in both plate heating and cooling process or directions, taking into account also the thermal hysteresis of the switch, which leads to a lower switching point during cooling.

In the prior art radiant heaters, detecting the residual cooking plate temperature is effected by means of a bimetallic sensor separated from the plate itself, presents the problem of the influence of the heat transmitted from external adjacent heaters, which raises the ambient temperature and heats the peripheral wall of the heater equipped with the bimetal switch. This problem is particularly evident in the case of the so-called “warmer” type radiant heater, which is used solely for warming precooked foods or holding them at the maximum plate temperature of around 300° C. The power of the heater is low compared with the adjacent cooking heaters of the same hob, which heat their respective hob area up to 550° C. For this reason the cover or metal support tray that encircles the heater, ends up hot due to the transmission of the adjoining heaters switched on at the same time. The problem of the temperature in the outer wall of the heater becomes critical when the ceramic body of the bimetallic sensor is submitted directly to heating from the adjoining heaters, so that the sensitive disc of the bimetallic switch may reach a temperature of around 100° C., and it loses correlation with the actual temperature of the plate area it has to detect. Alternatively, the outer heating of the built-in bimetallic switch may come from heat sources below the heater.

In the known solutions, for example that disclosed in DE-A-2627373, the thermal switch for turning on the warning lamp is fixed at the peripheral edge of the heater and for its operation it has an expanding rod coupled to the heating resistors from which it receives heat.

In U.S. Pat. No. 6,121,587 a second bimetallic switch built into the radiant heater operates at a temperature of less than 100° C. to indicate residual heat and is disposed in an air duct built into the insulating outer wall of the heater, so that no expanding rod is needed for its actuation. But attached to the sensitive element this sensor has an additional heat transmitting member that receives the radiation of the heating resistors in order to obtain a quick response of the heat sensitive element of the cooking plate. Owing to the influence of external heating on the sensor, the bimetal disc does not follow the variation in the plate area heated closely, and it therefore requires a high adjusting point for actuating the switching contact, well separated from the maximum warning threshold value of 80° C. at the hot plate.

Publication U.S. Pat. No. 6,756,569-B2 describes a radiant heater or “warmer” only for warming, which uses a bimetallic switch for turning on a “hot” plate warning lamp. The sensor is built into the heater secured between the peripheral insulating ring and the horizontal base of the heater, in a hole space shaped to the outline of the body of the sensor. Owing to the fact that the ceramic body has no heat insulation against the transmission of external heat, the bimetallic disc may reach a temperature of more than 100° C., even when the heater if off. Therefore, while the heater plate area is cooling, the temperature detected at the bimetallic sensor follows an almost asymptotic slope above 100° C. (represented by the dotted line in FIG. 4) and the response time of the sensor in opening the electrical contact is very long and out of touch. When the adjacent heaters are off, the sensor bimetallic disc reaches a temperature 40° C. lower than in the other case. It is thus hard to find a setting point for the switching of the electrical contact in both directions. Further, one certain point of actuation of the sensor being set, after adding the differential interval due to the actual switching hysteresis of the switch, the temperature difference in the plate area, the difference between the moment of closure and the moment of opening, may reach as much as 70° C., even larger than an acceptable signalling interval of 50-80° C.

The type of thermal switch or bimetallic sensor used in the heaters in the prior art are of the type described in US-A-4059817, provided with a cylindrical sensor body and a heat receiving metallic base in direct contact with the internal bimetallic temperature-sensitive disc. Another type of known bimetallic thermal switch incorporated in a radiant heater is described in publication DE-1123059-A, and it is also compact with a ceramic body whose heat-receiving side presents a recess through which a bimetallic plate is deformed, while the terminals are situated on the opposite side of the body, facing longitudinally.

### DISCLOSURE OF THE INVENTION

The object of the present invention is an electric radiant heater adapted to a cooking hob with a top plate of the type glass-ceramic, provided with at least a radiant heater of lower power for carried out the process “warming” or “maintenance” of food, which is equipped a thermal switch including a bimetal thermal switch sensitive to a temperature of the radiant heater, for switching on and off a hot plate warning indicator above and below a residual temperature threshold value in the heated plate area, wherein the bimetal sensor is positioned closed to a heating resistor segment, so that a quick and precise sensing response is obtained for said residual temperature.

The thermal sensing switch is fixed inside the heater separate from the cooking plate, isolated there from the influence of the adjacent heaters of the cooking hob. The temperature value detected is faithfully correlated to the true value in the heated plate area, both during heating and during cooling. Thereof the actuation of the switch is thereby achieved in both directions within an acceptable residual temperature range in the plate area of 65°±15.

The preferably bimetal type thermal switch is disposed in an air cavity within the heater under the cooking plate, wherein the heating resistors are mounted. The thermal switch used as a bimetal sensor, has a compact body whose heat receiving side for the sensing element is directly facing the radiation of the heating resistor, said receiving side resting according two embodiments closed to a portion of the heating resistor or otherwise over a resistor segment engaging therewith, depending on how is conformed the insulating surface for the heating resistor portion support and guide. Positioned in this way, the bimetal sensor is isolated from the influence of the external heating produced by the adjacent cooking heaters switched on at the same time. A quick sensor response to plate heating is also achieved as well as precise temperature detection during cooling, closely correlated to the real value in the heated plate area. The response time to cooling is not delayed unnecessarily, due to the fact that the bimetallic sensor is isolated from the metal cover of the warmer heater, through the interposition between them of the peripheral isolating wall thereof, and its air cavity in which the sensor is enclosed inside the heater.

The radiant heater according to the invention does not use additional fixing means either for the bimetallic sensor, since it is situated up against a central surface of the heating resistor insulating carrier or base. The sensor is secured and pressed here by the elastic force of rigid electrical connection cables. In this way, its position relative to the heating resistors is fixed and does not vary either moved by the thermal constraints in the sensor body.

### DESCRIPTION OF THE DRAWINGS

FIG. 1 is a plan view of a radiant electric heater adapted to a cooking plate, with a built-in thermal switch positioned as a bimetal sensor for a temperature indicator, according to first embodiment.

FIG. 2 is a partial sectional view of the radiant heater under the cooking plate according to line II-II in FIG. 1.

FIG. 2A shows a detail of the heater in FIG. 2, the relative position of the bimetal sensor within the radiant heater.

FIG. 3 is a close view of the radiant heater in FIG. 1, showing a variant of the thermal switch construction.

FIG. 4 is a diagram of the resultant temperature in the cooking plate area by the radiant heater of FIGS. 1-3, compared with the temperature value at the bimetal sensor.

### DETAILED DESCRIPTION OF THE INVENTION

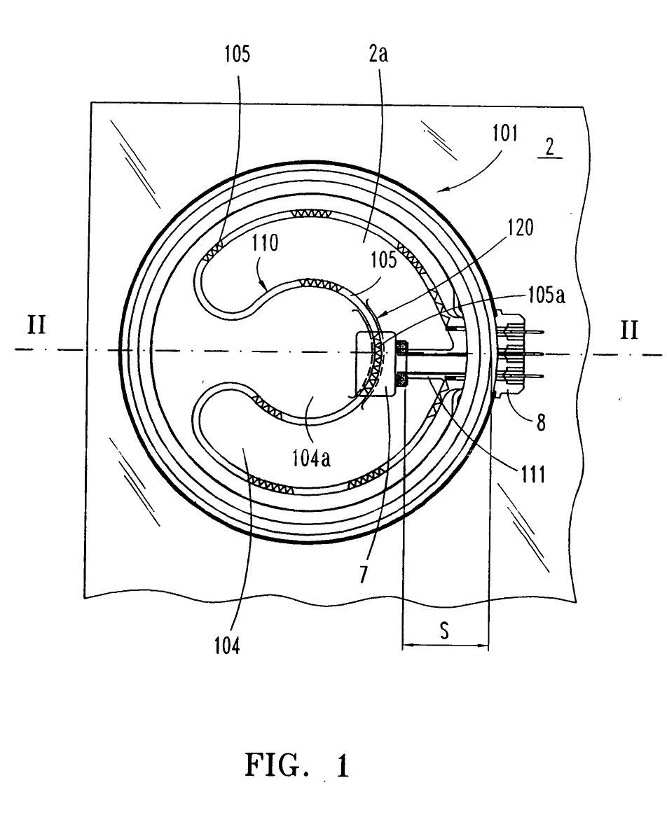

In reference to FIGS. 1-4, a preferred embodiment of radiant heater 101 is attached to cooking plate 2 of a cooker hob with various radiant heaters (not represented in the drawings), which are arranged below the cooking plate and close to one another, and the radiant heater 101 is formed of a cover or metal tray 3, an insulating base 4 holding a least one heating resistor, a peripheral insulating ring 6 in contact with the cooking plate, a compact thermal switch or bimetallic sensor 107, disposed in an air cavity 13 formed below the heated plate area 2a, between the insulating base 104 and the insulating ring 6, and an electrical connector 8, which transmits the power directly to the resistors.

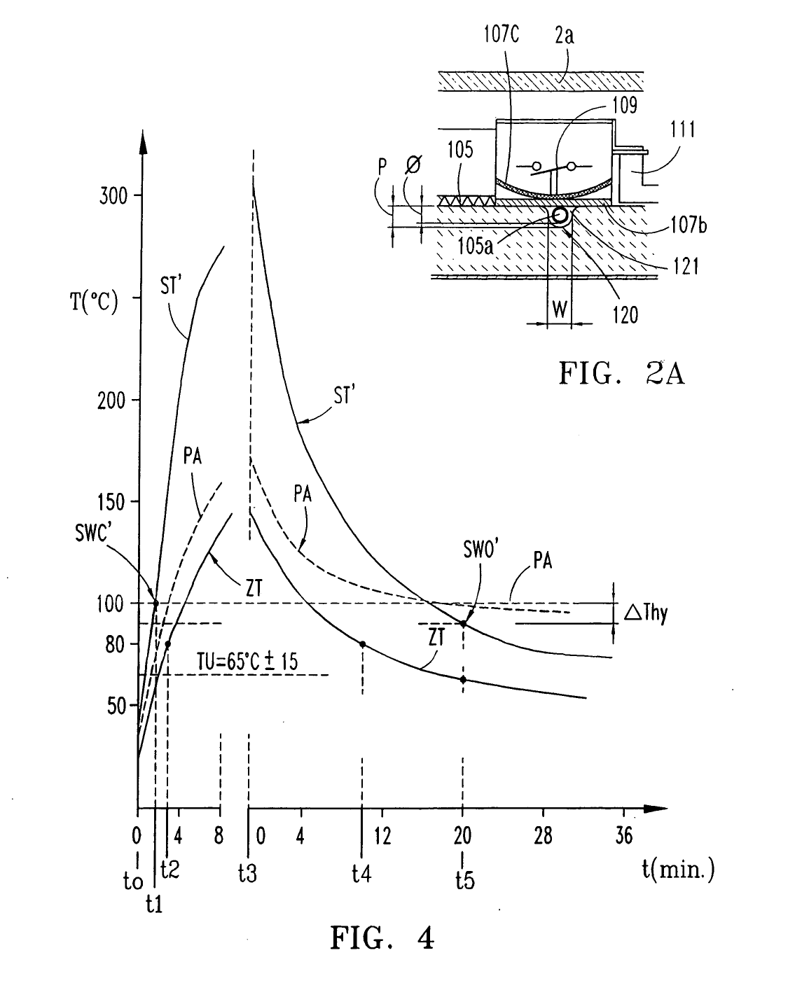

The bimetallic sensor 107 has a compact, electrically insulating body 107a made of ceramic material resistant to the high temperature that is transmitted from the heating resistor 105. It is constructed with an external metal base 107b, 107d receiving heat on one side of the compact body 107a, and a bimetal disc 107c sensitive to the temperature connected thermally to said metal base 107b, 107d. A normally-open electrical contact 109 of the sensor is actuated at the regulated switching point SWC′ (FIG. 4), which, upon closing, provokes the ignition of a signalling lamp or other “plate hot” warning device (not represented in the drawings) advising of the residual temperature of the heated plate area 2a.

The power of the heater described here as a specimen embodiment is 250 W, normally lower than the power of the adjacent 750-1250-watt hotplates. The heating resistor 5 may be made in planar or wire coil form and it is installed on a central surface area 104a of the insulating base guided in a groove 110. A commercial bimetal sensor 107 is chosen on grounds of economic cost and its compact body 7a is preferably square section and low height so as not to interfere in the installation of the glass ceramic plate on the radiant hotplate.

The height “H” of the air cavity 13 is 20-25 mm, similar to that of other heaters. Between the plate area 2a and the bimetal sensor 107 there is a separating space “B”, for instance of 3 mm or less, i.e. a fitting clearance “B” the same as that of other cooking hotplates in order to use the same insulating ring 6 and metal tray 3 pieces. A minimal separating space “B” from the plate area 2a is preferable in order to improve the correlation between the “ZT” temperatures in the area of plate 2 and the “ST” in the bimetal sensor 107. The compact body of the sensor 107a is insulated from the external thermal influence of the adjacent heaters, separated from the insulating ring 6 by an intervening space “S” , the size of which depends on the distribution of the segments of heating resistor 105 and its coil-like configuration. The bimetal sensor 107 is disposed in the air cavity 13 of the radiant heater 101, resting on the central surface area 104a of the insulating base above a segment of resistor 105a in order to improve heat transmission form the heating resistor 105 to the bimetal sensor 107.

Said heating resistor segment 105a is guided in a segment of insulating guiding groove 120, 120′. The heat-receiving metal base 107b, 107d is supported on the segment of guiding groove 120, substantially in contact with the resistor segment 105a, or separated from the latter by a very small accidental space, depending on the dimensional deviations of the insulating base 104a and the compact body of the sensor 107a. Owing to the formation of a protective layer of surface metallic oxide on the resistor 105, the metal base 107b, 107d is insulated electrically from the resistor segment 105a.

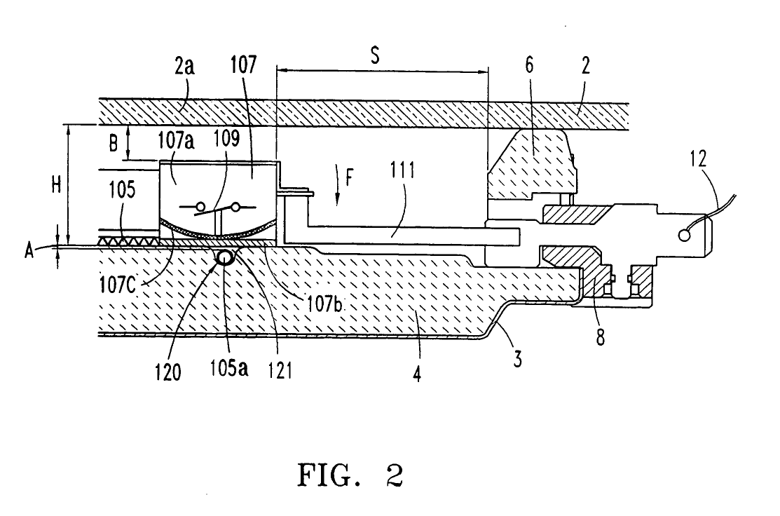

In reference to FIG. 2, an embodiment of heater 101 is shown in which said resistor segment 105a is housed in an insulating groove 120, of a width “W” and a depth “P” . The metal base 107b of the bimetal sensor is completely flat and straight and the resistor segment 105a is fully sunken in the housing groove 120. The depth “P” and the width “W” of the groove are greater than the diameter “φ” of the resistor 105a. Between the metal base 107b and the housing groove 120 an air channel 121 is formed which constitutes a source of heat for the bimetal disc 107c. In the event of said spatial clearance “A” being such that there is no actual contact between the resistor segment 105a and the metal base 107b, 107d of the sensor, the air channel 121 transmits with the same efficacy the heat from the resistor segment as if said thermal contact actually existed between them. In this way, consistency of results is achieved on all the units of radiant heater 101 manufactured with the built-in bimetal sensor 107 in the detection of an “ST” temperature in the sensor (FIG. 1) correlated to the range 65″C±15 of temperature “ZT” in the heated area 2a of the cooking plate.

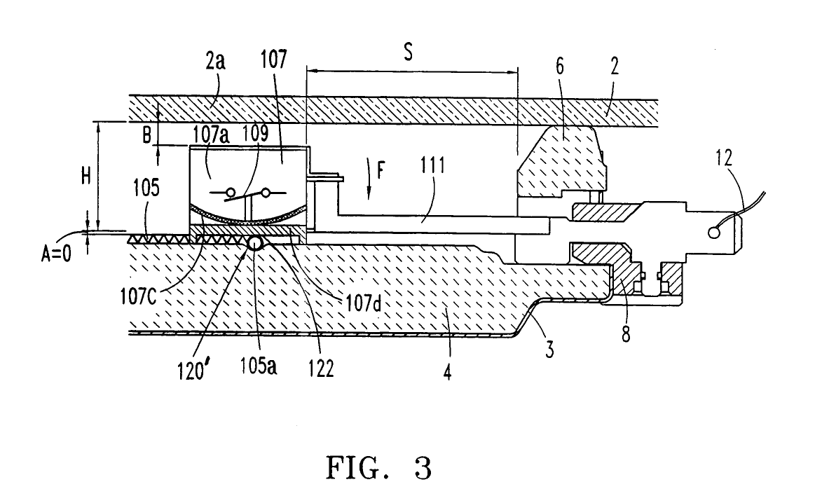

In reference to FIG.3, a version of radiant heater 101 is shown in which said resistor segment 105a is fixed in a surface guiding groove 120′ the same as the heating resistor 105 guiding groove 120′. The resistor segment 105a stands proud here of the insulating support surface area 104a, and the sensor metal base 107d lies above the guiding groove 120′ in contact with the resistor segment 105a, forming an air channel 122 that transmits heat to the metal base 107d. To prevent it from being flattened, the metal base 107d is substantially straight but with two projections squared on the side edges, between which the resistor segment 105a passes, standing proud of the insulating base 104a. The metal base 107d may also be formed according to other versions, for example by means of two inclined walls 114 forming a triangular cavity for the resistor segment 105a on the insulating support surface area 104a, or else with a single lateral projection 114 forming an angle with the straight metal base 107d, thus positioned with an inclination on the insulating support surface area 104a. By means of these versions of the metal base 107d a cavity is formed on the insulating surface area 104a, by way of which the resistor segment 105a passes, making substantially a thermal contact with it.

The sensor electrical contact 109 is connected by two rigid cables 111 to the peripheral electrical connector 8, from which the signalling lamp is illuminated via a line 12. For the fastening of the bimetal sensor 107 on the heater, the elasticity of the metal cables 111 extended with a small angle of inclination, produces a force “E” applied to the body of the sensor 107a against the insulating support surface 104a. The position of the sensor 107 is thus held fixed against the movements produced by the thermal stresses.

If the radiant heater 101 has the resistor segment 105a protruding from the surface 104aof the insulating base, the bimetal sensor 107 may optionally be positioned very close to the resistor segment 105a, with the vertical metal base 107b oriented towards it and a very small distance “A” apart, including also the contact distance A=0 between them, in order that the installation of the bimetal sensor 107 will not interfere with the resistor 105.

In reference to FIG. 4, in a temperature (T)/time (t) diagram the results are shown of the actual measurement at the plate area 2a, represented by a curve ZT, and of the temperature detected by the bimetal sensor 107, represented by a curve ST′, wherein the bimetal sensor 107 has been positioned above the resistor segment 105a, in either of the two embodiments of FIG. 2-2A and FIG. 3. Curve PA represents the changes in the temperature in the bimetal sensor in afore-mentioned heater of the prior art.

The temperature curve “ZT” has been measured in the heated plate area 2a, with a food container on top, and has reached around 150° C. The bimetal sensor 107 has been regulated at the switching point SWC SWO′ of the switch contact 109, for example SWC′=100° C. and SWO′=90° C., the most suitable during the cooling process, in the most unfavourable condition for the cooling of the bimetal sensor 107, the radiant heater 101 being subject to the influence of the adjacent cooking heaters that are also in operation. Characteristic of a commercial type thermal switch or bimetal sensor 107, it is an intermediate setting of the switching point SWC′, SWO′ of the electrical contact between the two rising and falling values, respectively, which has been found as appropriate 100° C. A differential hysteresis value “AThy” between SWC′ and SWO′ is represented.

The instants of time “t0” to “t5 ” marked in the diagram of FIG. 4 correspond to: t0: heater ON; t1: temperature ST′ rising, the setting point SWC′=100 is reached for the closure switching of the electrical contact 109; t2: temperature “ZT” rising, the plate area 2areaches a value in the signalling range TU=65° C.±15; t3: heater OFF; t4: plate 2a falls until reaching a value in the signalling range TU=65° C.±15; t5: it is reached with the setting point SWO′=100° C.−“AThy” dropping, for the opening switching of the electrical contact 109.

Due to a rapid heating of the bimetal sensor 107, the switching instant “t1” of the electrical contact 109 is reached quickly, before 1 minute has passed from the start t0 of the heating of the plate ZT, when the latter reaches the minimum signalling lamp ignition threshold value TU=50° C.

During the lowering of temperature ZT, the switching instant “t5” at the setting point SWO′=90° C. of the electrical contact 109 is reached without delay in respect of the mean value TU=65° C. of the plate area 2a, since curve ST′ of the bimetal sensor has a down-slope in close correlation to the plate curve ZT. The air channel 121 below the bimetal sensor 107 cools at the same time as plate area 2a when the heating resistor is OFF. With regard to instant “t4” in the fall down to the maximum admissible temperature without signalling TU (max)=80° C. of the plate, the delay interval t5-t4, around 10 minutes, in the opening switching of the electrical contact 109 without the lamp going off is acceptable by the user.

In the diagram in FIG. 4 the curve PA obtained in the afore-mentioned prior art heater, wherein the bimetal sensor is inserted in the peripheral wall of the heater, has been interposed. Due to its indirect warming from the adjacent cooking heaters, during cooling the sensor does not detect the variation in the temperature of the plate area below 100° C., so the switch has to be set at a very high opening point in relation to the highest plate temperature TU (max)=80° C. admissible, or otherwise the delay in switching, instant “t5” , may be extended indefinitely, even when the plate temperature has dropped below the minimum indication value “TU (min)”=50° C.

What it is claimed is:

1. - A radiant heater adapted to an electric cooking hob with a glass ceramic type hotplate and at least said radiant heater comprising:
an insulating base (104) substantially parallel to the top hotplate (2), and a heating resistor (5) extended according to a given geometric configuration supported on the central surface area (104a) of the insulating base, a peripheral wall of the insulating ring (6) defining a heated plate area (2a) and an air cavity (13) along with a central surface area (104a) in the insulating base, an outer cover or metal tray (3) forming with said insulating ring (6) an outer peripheral wall (3,6) of the radiant heater, a thermal switch (107) of the bimetal sensor type built into the radiant heater, and an electrical power connector (8) fixed in said peripheral wall (3,6).
wherein the bimetal sensor (107c) of the thermal switch is provided with a heat-receiving metal base (107b,107d) for the detection of a temperature value (ST) in the bimetal sensor (107c) in correspondence with the actual temperature (ZT) of the plate area (2a), and with an electrical contact (109) associated with the bimetal sensor (107c) which is set at a switching point (SWC′,SWO′) correlated to a low temperature range (TU) of the plate area (2a) during the two radiant heater heating and cooling processes, for the switching of an indicator of the condition of hot plate (2a), and
said thermal switch (107), having a compact body (107a) of heat-resistant ceramic material, is fixed in a given position (A,S) in said air cavity (13) below the heated plate area (2a), such that the compact body (107a) of the switch is supported on said central insulating surface area (104a) insulated thermally from said peripheral wall, and with said metal base (107b,107d) oriented towards at least one segment of the heating resistor (105a), and positioned very close (A) to a segment of said heating resistor (105a) or substantially in direct thermal contact with it, for the direct reception of the heating radiation on the bimetal sensor (107).

2. - Electric radiant heater according to claim 1, wherein said resistor segment (105a) is guided in a groove (120,120′) in the central area of the insulating base (104a), and the metal base (107b,107d) of the bimetal sensor is positioned above said segment (105a) of the heating resistor, resting on the insulating base (104).

3. - Electric radiant heater according to claim 1, wherein said resistor segment (105a) is housed entirely in said insulating groove (120), and sensor the metal base (107b) is supported on the insulating base (104) forming on said insulating groove (120) a hot air channel (121) transmitting heat to the bimetal sensor (107c), together with the direct radiation of the resistor segment (105a).

4. - Electric radiant heater according to claim 1, wherein said resistor segment (105a) is partly housed in said surface groove (120′) with a radiant part of it standing proud of the central area (104a) of the insulating base, and the metal sensor base (107d), which is positioned in direct contact with said resistor segment (105a), forms up against the latter a hot air channel (122) transmitting heat to the bimetal sensor (107c) together with the direct radiation of the resistor segment (15a).

5. - Electric radiant heater according to claim 1, wherein the compact sensor body (107a) being supported on said central area (104a) of the insulating base and there remaining a fitting clearance (B) from the heated plate area (2a), the bimetal sensor (107) comprises terminals and at least one rigid cable (111), which extends towards the outer electrical connector (8) in said heater peripheral wall (3,6), exerting an elastic force (F) which presses the compact body (107) of the bimetal sensor (107) securing it up against said central insulating support area (104a).
